(19) United States
(12) Patent Application Publication
(10) Pub. No.: US 2013/0088416 A1
(43) Pub. Date: Apr. 11, 2013

(54) OLED Display Driver Circuits and Techniques

(71) Applicants: Euan C. Smith, Cambridgeshire (GB); Aleksandra Rankov, Huntingdon (GB)

(72) Inventors: Euan C. Smith, Cambridgeshire (GB); Aleksandra Rankov, Huntingdon (GB)

(73) Assignee: CAMBRIDGE DISPLAY TECHNOLOGY LIMITED, Cambridgeshire (GB)

(21) Appl. No.: 13/621,437

(22) Filed: Sep. 17, 2012

(30) Foreign Application Priority Data
Oct. 11, 2011 (GB) 1117533.8

(51) Int. Cl. G09G 3/32

(52) U.S. Cl. 345/76

(57) ABSTRACT

We describe a method of driving an OLED display. The OLED display comprises a plurality of pixel driver circuits on chiplets, each pixel driver circuit comprising an output transistor for driving a first connection of an associated OLED pixel. A cascode transistor on the chiplet is coupled between the output transistor and the first connection of said associated OLED pixel. A power supply is provided to the chiplet, defining a chiplet voltage range. A second connection of the associated OLED pixel is connected to an OLED voltage outside said chiplet voltage range. The OLED pixel is then driven using the pixel driver circuit on the chiplet over an OLED voltage range greater than said chiplet voltage range. In some preferred embodiments a drain connection of the cascode transistor is set at a voltage below a ground or negative (Vss) power supply to a chiplet.

### FIELD OF THE INVENTION

This invention relates to techniques for driving organic light emitting diodes (OLED) displays, in particular using display driver circuitry fabricated on a plurality of small integrated circuits (chiplets).

### BACKGROUND TO THE INVENTION

It is known to drive an OLED display using an active matrix arrangement in which individual pixels of the display are activated by an associated thin film transistor (TFT). The brightness of an OLED pixel of such a display may be programmed by either a voltage or a current. (In this specification references to ‘pixels’ are to be interpreted as including different coloured sub-pixels of a colour display). In either case a typically memory element is associated with each pixel so that the data written to a pixel is retained whilst other pixels are addressed. Generally this is achieved by a storage capacitor which stores a voltage set on the gate of a driver transistor, which in turn dictates the current through the OLED pixel. However the voltage on the gate of the TFT driver transistor, and hence the OLED current, may be programmed by either a voltage or a current (and in the latter case the programming current may directly set the OLED current by driving the OLED with a scaled version of the programming current).

The use of thin film transistors has a number of associated difficulties, in particular because amorphous silicon is unstable in that its threshold voltage and carrier mobility shifts over extended periods of use, whilst polysilicon often exhibits a large degree of variability in the same parameters across the display substrate. One approach to address these problems is described in our earlier patent application WO2010/019185, which describes the use of chiplets, that is small (crystalline silicon) semi conductor integrated circuits which are attached at intervals onto the display substrate, each driving a set of associated pixels, for example each chiplet controlling the current to four pixels or 12 RGB sub-pixels.

With such an arrangement it is desirable to be able to reduce the area of silicon employed which would also reduce the cost.

### SUMMARY OF THE INVENTION

According to a first aspect of the invention there is therefore provided an organic light emitting diode (OLED) display, the display comprising: a display substrate bearing a plurality of OLED pixels and having a plurality of chiplets mounted on said display substrate, wherein each said chiplet comprises a silicon integrated circuit coupled to a set of one or more said OLED pixels and bearing one or more pixel driver circuits for said set of one or more OLED pixels, and wherein each said chiplet is located adjacent said set of OLED pixels to which it is coupled; wherein a said pixel driver circuit comprises an output pixel driver transistor having first and second drain/source connections and a control connection; wherein said first drain/source connection is coupled to a first power supply line of said chiplet; wherein said second drain/source connection provides a drive output to an associated said OLED pixel; and wherein said pixel driver circuit further comprises a cascode transistor coupled between said second drain/source connection of said output pixel driver transistor and said associated OLED pixel, said cascode transistor having a first drain/source connection coupled to said second drain/source connection of said output pixel drive transistor, a second drain/source connection coupled to a first connection of said associated OLED pixel, and a control connection coupled to a bias voltage line.

Embodiments of the above described technique; although they employ an additional, cascode transistor enable the use of a lower voltage process, with an overall reduction in the area of silicon, and thus a concomitant reduction in silicon cost.

In embodiments the chiplets are provided with a power supply connected to the first, for example V_{DD} power supply line/connection of a chiplet, and to the second, for example ground, power supply connection to a chiplet, which may comprise a connection to the substrate of the chiplet. The power supply defines a power supply voltage range and the techniques we describe enable an associated OLED pixel to be driven with a voltage outside this range. For example a drain connection of the cascode transistor may be connected to an anode of the associated OLED pixel and the cathode of the OLED pixel may be connected to an OLED power supply line or connection at a negative voltage, that is below the substrate potential (ground). In this way the voltage swing on the OLED as it is driven between fully off and fully on states may be greater than the power supply voltage range of the chiplet. Furthermore the techniques we describe are able to achieve this without requiring level shifters between the pixel driver control circuitry and output stage, which would otherwise increase the silicon area.

To facilitate use of a cascode transistor as described above it is desirable for the cascode transistor to lack a forward conducting parasitic diode between the second drain/source connection of the cascode transistor and the second, for example ground, power supply connection to the triplet (when this second drain/source connection is outside the power supply voltage range of the pixel driver circuit). Thus where the substrate of the chiplet is connected to ground there should be no such forward conducting parasitic diode to ground. More generally, where the cascode transistor is a p-type transistor there should be no parasitic diode between the drain connection of this transistor and ground; where the cascode transistor is an n-type transistor there should be no parasitic diode between the drain connection and a positive power supply connection to the chiplet. In either case the OLED display employs a separate OLED power supply connection to the second connection of an OLED pixel, that is the connection not driven by the cascode transistor. Further, where the chiplet employs an output pad to couple the cascode transistor to the OLED pixel, this should also lack a parasitic diode to the substrate of the chiplet.

As previously mentioned, a voltage on the OLED power supply connection is outside a power supply voltage range for the chiplet, for example more negative than a ground voltage of the chiplet. Further a difference in voltage across an OLED pixel between the on-and off-states of the pixel may then be greater than the power supply voltage range to the chiplet. To reduce the risk of triggering the parasitic drain-bulk diode into forward conduction when applying a negative drain potential, in embodiments the cascode transistor may be partially or substantially wholly electrically isolated from the substrate of the chiplet. This may be achieved by using an isolated MOS fabrication process. Additionally or alternatively the source and bulk connections of the cascode transistor may be connected together so that the source and bulk are at a common potential (zero) volts. Preferably the cascode transistor is then further configured such that the drain-bulk voltage is substantially zero when applying a negative voltage to the drain. This may be achieved by adjusting the potential of a well (p-well or n-well) in which the device is fabricated, for example by adjusting the implantation of this well. Thus the pixel driver circuit may be fabricated on a chiplet using a process with a maximum specified voltage which is less than a voltage or voltage range driving the associated OLED pixel, for example a 3.3 volt process where the change in voltage at the drain of the cascode transistor is greater than 3.3 volts.

In a related aspect the invention provides a method of driving an OLED display, the method comprising: providing a plurality of pixel driver circuits for the OLED display on a plurality of chiplet silicon substrates, wherein each said pixel driver circuit comprises an output transistor for driving a first connection of an associated OLED pixel; providing a cascode transistor on a said chiplet silicon substrate, wherein said cascode transistor is coupled between said output transistor and said first connection of said associated OLED pixel; providing a power supply to said chiplet silicon substrate, said power supply defining a chiplet voltage range; providing a second connection of said associated OLED pixel with an OLED voltage outside said chiplet voltage range; and driving said associated OLED pixel using said pixel driver circuit on said chiplet over an OLED voltage range greater than said chiplet voltage range.

Preferably the cascode transistor is arranged so that there is no forward conducting parasitic diode connected to the first, for example anode, connection of the associated OLED pixel. Thus the cascode transistor may be fabricated such that it is substantially electrically isolated from the silicon substrate of the chiplet and/or the source and bulk connection of the cascode transistor may be arranged to be at a common potential, and the transistor configured such that the drain-bulk voltage is zero at some negative drain voltage, that is at a voltage outside the voltage range of the chiplet power supply. The bias voltage for the cascode transistor may be selected so that this is within the power supply range; it may be selected so that the cascode transistor is always at least in a minimal on-state to provide a channel for the programming current supplied/taken by the output transistor to/from the OLED pixel. This voltage may be defined by a bias voltage generator on the chiplet and/or it may be set by a signal on a common biasing line for multiple chiplets of some/all of the display. In some preferred embodiments a drain connection of the cascode transistor is set at a voltage below a ground or negative (Vss) power supply to a chiplet.

In a further aspect the invention provides a system for driving an OLED display, the display comprising: a plurality of pixel driver circuits for the display on a plurality of chiplet silicon substrates, wherein each said pixel drier circuit comprises an output transistor for driving a first connection of an associated OLED pixel; a cascode transistor on a said chiplet silicon substrate, wherein said cascode transistor is coupled between said output transistor and said first connection of said associated OLED pixel; and a power supply to said chiplet silicon substrate, said power supply defining a chiplet voltage range; a line connecting a second connection of said associated OLED pixel to an OLED voltage outside said chiplet voltage range; wherein a said pixel driver circuit is configured to drive said associated OLED pixel using said pixel driver circuit on said chiplet over an OLED voltage range greater than said chiplet voltage range.

Again, in some preferred embodiments a drain connection of the cascode transistor is set at a voltage below a ground or negative (Vss) power supply to a chiplet.

### BRIEF DESCRIPTION OF THE DRAWINGS

These and other aspects of the invention will now be further described by way of example only, with reference to the accompanying Figures in which:

FIG. 1 shows an illustration of a portion of an OLED display including a chiplet integrated circuit;

FIGS. 2a to 2c show examples of OLED pixel drive circuits, respectively, setting a gate voltage on the drive transistor, using a current mirror, and employing a current copy technique;

FIG. 3 shows a pixel driver circuit output stage according to an embodiment of the invention;

FIG. 4 shows lifetime data as a function of channel length and drain-source voltage (VDS) for a cascode transistor operating in a pixel driver circuit according to an embodiment of the invention; and

FIGS. 5a and 5b show, respectively, a portion of an OLED display incorporating chiplets bearing pixel driver circuits according to embodiments of the invention, and an OLED display system incorporating the OLED display of FIG. 5a.

### DETAILED DESCRIPTION OF PREFERRED EMBODIMENTS

Broadly speaking we will describe pixel driver circuit techniques for inclusion of an output cascode stage where the output can drop below ground potential. Further, the output can be used at a greater voltage than that of the silicon process, and the techniques enable a higher voltage range output than that of the nominal silicon process.

We first describe example chiplets and pixel driver circuits, as this is helpful for understanding embodiments of the invention.

### Chiplets

Implementations of the embodiments of the invention use chiplets for the pixel drive circuitry. In broad terms these comprise small silicon integrated circuits which are stuck onto the glass substrate of a display and connected to OLED pixels and to external connections of the display.

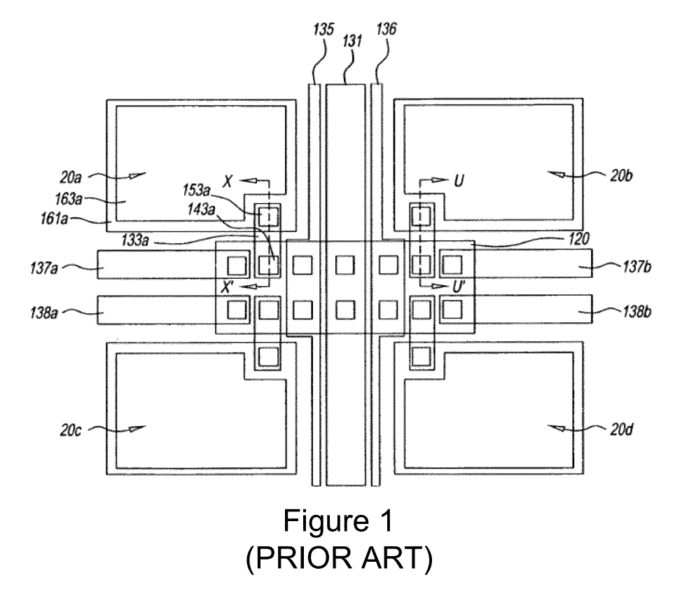

FIG. 1 which is taken from WO 2010/019185 shows a layout view of a group of four pixels (20a, 20b, 20c and 20d) elements of an OLED display device. Each of the four pixels can be arranged to emit a different colour, such as red, green, blue and white (RGBW). FIG. 1b represents a portion of a full display where the full display would be constructed of an array of such groups of pixels arranged in many rows and columns. For example, a modern television would be constructed having 1920 rows and 1080 columns of such groups of pixels.

A chiplet 120 is arranged to control the electrical current to pixels 20a, 20b, 20c and 20d. A chiplet is a separately fabricated integrated circuit which is mounted and embedded into the display device. Much like a conventional microchip (or chip) a chiplet is fabricated from a substrate and contains integrated transistors as well as insulator layers and conductor layers which are deposited and then patterned using photolithographic methods in a semiconductor fabrication facility. These transistors in the chiplet are arranged in a transistor drive circuit to drive the electrical current to pixels of the display. A chiplet is smaller than a traditional microchip and unlike traditional microchips, electrical connections need not be made to a chiplet by wire bonding or flip-chip bonding. Instead, after mounting each chiplet onto the display substrate, deposition and photolithographic patterning of conductive layers and insulator layers continues. Therefore, the connections can be made small, for example through using vias 2 to 15 micrometers in size. The chiplet and connections to the chiplet are small enough to be placed within the area of one or more pixels which, depending on the display size and resolution, may range from approximately 50 micrometers to 500 micrometers in size. Additional details on chiplets and their fabrication and mounting processes can be found in WO '185.

Each pixel is provided with a lower electrode, such as a lower electrode 161a in pixel 20a. The emitting area of pixel 20a is defined by an opening 163a in an insulator formed over the lower electrode. The device includes multiple conductive elements formed in a first conductive layer which are arranged to facilitate providing electrical signals to the chiplet's transistor drive circuitry to enable the chiplet to control electrical current to the pixels. Chiplet 120 controls current to pixel 20a through a conductor 133a. For example, conductor 133a is connected to chiplet 120 through a via 143a and is also connected to lower electrode 161a through a via 153a. The device also includes a series of signal lines including, power lines, data lines, and select lines which are formed in the first conductive layer and transmit electrical signals from the edge of the display to the chiplets. Power lines are signal lines that provide a source of electrical current to operate the organic electroluminescent elements. Data lines are signal lines which transmit bright information to regulate the brightness of each pixel. Select lines are lines which selectively determine which rows of the display are to receive brightness information from the data lines. As such select lines and data lines are routed in an orthogonal manner.

Power is provided to the chiplet 120 by way of a power line 131. Two vias are provided for connection between the power line and the chiplet 120. A data line 135 is provided in the column direction for communicating a data signal containing brightness information to chiplet 120 for pixel 20a and pixel 20b. Similarly, a data line 136 is provided in the column direction for communicating a data signal containing brightness information to chiplet 120 for pixel 20b and pixel 20d. In an alternate arrangement the data lines 135 and 136 and the power line 131 can be connected to the chiplet 120 by only a single via for each line. A select line segment 137a is provided in the row direction for communicating a row select signal to chiplet 120 for pixel 20a and pixel 20b. The row select signal is used to indicate a particular row of pixels and is synchronized with the data signal for providing brightness information. Thus the row select signal and the data signals are provided in orthogonal directions. Chiplet 120 communicates the row select signal from select line segment 137a to a select line segment 137b by way of an internal pass-thru connection on the integrated circuit. Select line segment 137b then communicates the row select signal to subsequent chiplets arranged in the same row. Similarly a select line segment 138a is provided in the row direction for communicating a row select signal to chiplet 120 for pixel 20c and pixel 20d. Chiplet 120 communicates the row select signal from select line segment 138a to a select line segment 138b by way of another internal pass-thru connection on the integrated circuit. Select line segments 137a and 137b together serve to form a single select line, which is discontinuous. Connections between the select line segments are provided by the pass-thru connections in the chiplet. While only two segments are shown, the select line can contain a series of many such segments. Select line segments 138a and 138b similarly together serve to form a single discontinuous select line. All of the select lines segments and data lines may be formed from a single metal layer. Communication across the orthogonal array is then achieved by routing either the row select signal, the data signal, or both through the pass-thru connections on the chiplet.

### Active Matrix Pixel Circuits

It is also helpful to facilitate understanding of the operation of embodiments of the invention to describe examples of different types of analogue pixel drive circuits which may be employed in embodiments of the invention. Later we will describe a mixed analogue/digital drive circuit in which both the pixel drive level and pixel drive time are substantially proportional to a luminance data signal, and an embodiment of this circuit will be described using a current copy-type analogue pixel drive circuit. However other types of analogue pixel drive circuit which provide a variable pixel drive level to an OLED pixel may alternatively be employed including, but not limited to, those now described.

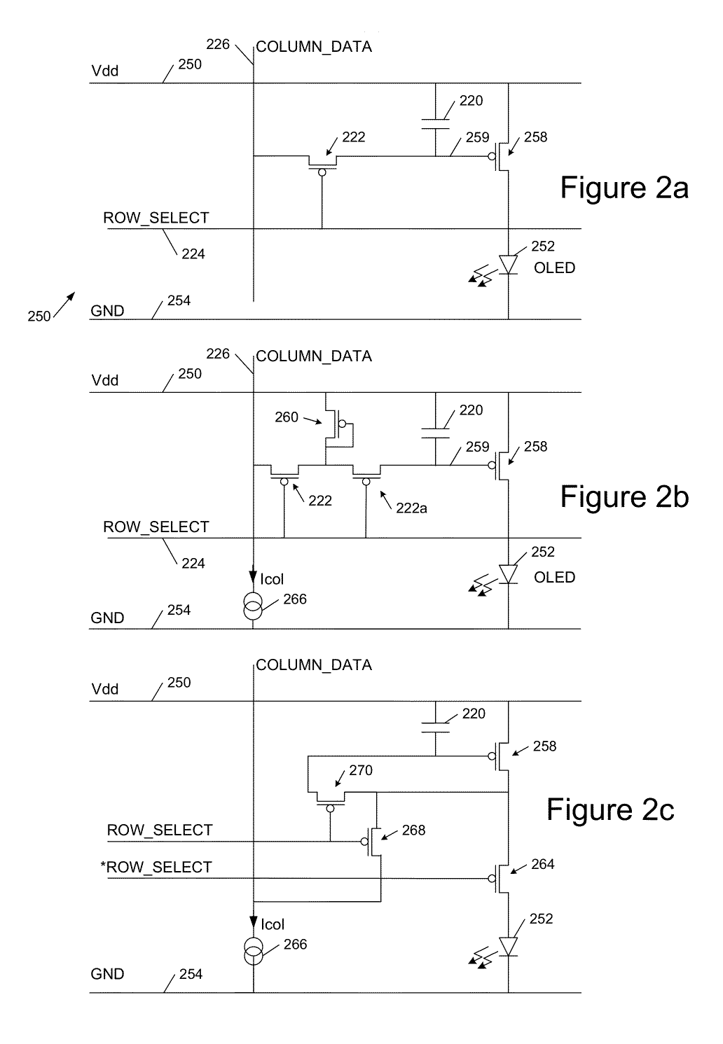

FIG. 2a shows an example of a voltage programmed OLED active matrix pixel circuit 250. A circuit 250 is provided for each pixel of the display and Vdd 252, Ground 254, row select 224 and column data 226 busbars are provided interconnecting the pixels. Thus each pixel has a power and ground connection and each row of pixels has a common row select line 224 and each column of pixels has a common data line 226.

Each pixel has an OLED 252 connected in series with a driver transistor 258 between ground and power lines 252 and 254. A gate connection 259 of driver transistor 258 is coupled to a storage capacitor 220 and a control transistor 222 couples gate 259 to column data line 226 under control of row select line 224. Transistor 222 is a thin film field effect transistor (TFT) switch which connects column data line 226 to gate 259 and capacitor 220 when row select line 224 is activated. Thus when switch 222 is on a voltage on column data line 226 can be stored on a capacitor 220. This voltage is retained on the capacitor for at least the frame refresh period because of the relatively high impedances of the gate connection to driver transistor 258 and of switch transistor 222 in its “off” state. Driver transistor 258 is typically a TFT and passes a (drain-source) current which is dependent upon the transistor's gate voltage less a threshold voltage. Thus the voltage at gate node 259 controls or programs the current through OLED 252 and hence the brightness of the OLED.

In the voltage-programmed circuit of FIG. 2a the OLED emission depends non-linearly on the applied voltage. The light output from an OLED is proportional to the current it passes, and FIG. 2b (in which like elements to those of FIG. 2a are indicated by like reference numerals) illustrates a pixel driver circuit which employs current control. More particularly a current on the (column) data line, set by current generator 266, programs the current through thin film transistor (TFT) 260, which in turn sets the current through OLED 252, since when transistor 222a is on (matched) transistors 260 and 258 form a current mirror.

FIG. 2c (which is taken from our earlier patent application WO03/038790) shows a further example of a “current copying” current-programmed pixel driver circuit. In this circuit the current through an OLED 252 is programmed by setting a drain source current for OLED driver transistor 258 using current generator 266, for example a reference current sink, and copying/memorising the driver transistor gate voltage required for this drain-source current. Thus the brightness of OLED 252 is determined by the current, I_{col}, flowing into reference current sink 266, which may be adjustable and set as desired for the pixel being addressed. A switching transistor 264 is connected between drive transistor 258 and OLED 252 to inhibit OLED illumination during the programming phase. In general one current sink 266 is provided for each column data line. To copy the programming current, switch transistor 268 is “closed” and switch transistor 264 is “opened” so that the programming current flows through drive transistor 258, and switch transistor 270 is also closed to set Vg on drive transistor 270 for the programmed current and to store this Vg value on capacitor 220.

The techniques we describe below can be applied to all of these circuits—which are merely given as examples—and to other OLED pixel driver circuits.

### Cascode Transistor Output Driving Stage

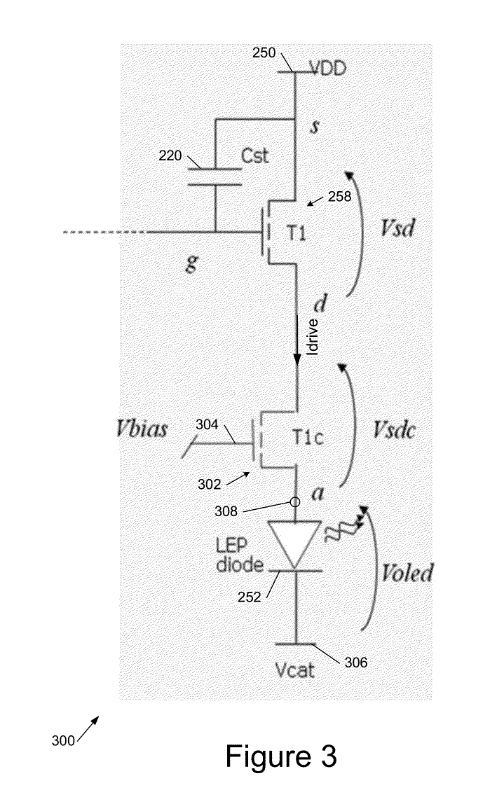

Referring now to FIG. 3, this shows an embodiment of a pixel driver circuit output stage 300 according to the invention. Like elements to those previously described are indicated by like reference numerals. Thus the output stage comprises a drive transistor (T1) 258 coupled in series with a cascode transistor (T1c) 302 to the OLED (light emitting polymer diode) 252. In the illustrated embodiment transistors 258 and 302 are p-type transistors, the source of drive transistor 258 is coupled to V_{DD}, the gate of transistor 250 to the storage capacitor (Cst) 220 and the drain of transistor 258 provides a drive current Idrive for the OLED 252. The drain of transistor 258 is coupled to the source of cascode transistor 302; the gate of cascode transistor 302 is coupled to a bias voltage line (Vbias) 304, and the drain of cascode transistor 302 is coupled to the anode of OLED 252. The cathode of OLED 252 is coupled to an OLED cathode voltage line (Vcat) 306. The pixel driver circuit, and in particular the output stage 300, is implemented on a chiplet of the general type previously described.

The effect of cascode transistor 302 is to reduce voltage variations on the drain connection of driver transistor 258 whilst allowing the voltage on the OLED 252 to vary: a large change in the drain voltage of the cascode transistor produces only a small voltage change in the source voltage of the cascode transistor, which is also the drain voltage of the driver transistor 258.

In embodiments of the invention, by comparison with the arrangements of FIG. 2, the cathode voltage line 306 is negative, that is below ground potential. Furthermore a low voltage, for example 3.3V, process is used for both the driver transistor 258 and the remainder of the chiplet circuitry and the cascode transistor 302 is used to protect transistor 258 from the larger voltage range that results from this arrangement: the cascode device 302 is able to sustain or drop a larger voltage than standard process limitations. To achieve this the circuit is arranged so that the drain of cascode transistor 302 lacks a (forward conducting) parasitic diode to ground. There may also be a pad 308 connecting the chiplet to the OLED anode, and if present this should also lack a (forward conducting) parasitic diode to ground. We describe later how this can be achieved.

The relation of a circuit will now be further described by way of examples of voltages within the output driving stage 300 under different conditions. In the following, the voltage across the OLED is denoted the Voled, the source-drain voltage of the cascode transistor is Vsdc, the source-drain voltage of the driver transistor is Vsd, the maximum V_{DD} track voltage drop is denoted by Vtrack, the minimum V_{DD} voltage is Vddmin, the drain voltage of the driver transistor is Vd, the anode voltage of OLED 252 is Va, the voltage between the drain of the driver transistor and the anode of the OLED is Vda.

Table 1 below is a set of example voltages for the case when the OLED 252 is fully on.

TABLE 1
OLED fully ON

| | |
|---|---|
| Module | 3.3 |
| Vdd (V) | 3.3 |
| Vtrack max drop (V) | 0.5 |
| Vbias (cascode T1c) | 0.5 |

Oled fully ON (10 μA)

| | |
|---|---|
| Vddmin (V) | 2.8 |
| Vsd (V) [T1] | 1.5 |
| Vd [T1] | 1.3 |
| Va (anode) | 0 |
| Vsdc (=Vda) | 1.3 |
| Voled (V) | 6 |
| Vcat (V) | −6 |

The analogue voltage of the OLED is zero volts and the cathode voltage line is at −6 volts so that there is 6 volts across the OLED. The cascode transistor is biased on (in saturation), with a bias voltage of +0.5 volts. The drain voltage of the driver transistor is at 1.3 volts (and the OLED drive current is set by the voltage on capacitor 220).

Now consider the voltages when the OLED is fully off, as shown in table 2 below (the module, Vdd, Vtrack, and cascode transistor bias voltage Vbias are the same as before).

TABLE 2
OLED fully OFF
Oled OFF

| | |
|---|---|
| Vddmin (V) | 2.8 |
| Vsd (V) [T1] | 1.5 |
| Vd [T1] | 1.3 |
| Va (anode) | −3 |
| Vsdc (=Vda) | 4.3 |
| Voled (V) | 3 |
| Vcat (V) | −6 |

The cathode voltage of the OLED is unchanged at −6 volts but the anode voltage of the OLED is at −3 volts so that the OLED is off. The drain voltage of the driver transistor 258 is substantially unchanged at 1.3 volts but the source/drain voltage of the cascode transistor 302 is now 4.3 volts, that is greater than the 3.3 volt process used for the circuitry.

The gate-source voltage of the cascode transistor is set so that this transistor is in a minimal required on-state; the source voltage of the cascode transistor varies only slightly but the circuit enables the drain voltage of the cascode transistor to vary substantially. The voltage across the cascode transistor (Vsdc=Vda) is largest when the OLED is off since the anode voltage reduces and the drain of the drive transistor gets closer to Vdd.

Table 3, below shows an intermediate case in which the OLED is on at 20% of the full current:

TABLE 3
OLED fully on, at 20% of full current
Oled 20% ON (l = 2 μA)

| | |
|---|---|
| Vddmin (V) | 2.8 |
| Vsd (V) [T1] | 1.5 |
| Vd [T1] | 1.3 |
| Va (anode) | −1.7 |
| Vsdc (=Vsa) | 3 |
| Voled (V) | 4.3 |
| Vcat (V) | −6 |

Again the drain voltage of the driver transistor 258 is substantially unchanged at 1.3 volts whilst the anode voltage of the OLED (the drain voltage of the cascode transistor) is at approximately −1.7 volts.

In the above circuits, the driver transistor 258 and the voltage applied to the gate of this transistor determine the OLED current, but the drain-source voltage of this transistor is limited and approximately constant because of the use of cascode transistor 302. Cascode transistor 302 has to sustain the highest voltage when the OLED is off; as the current supplied by driver transistor 258 increases, the voltage across the cascode transistor reduces.

The skilled person will appreciate that in the arrangement of FIG. 3, with the example voltages given above, the drain voltage of the cascode transistor is negative, except when the OLED is fully on. However a MOS transistor has a number of parasitic components and, in particular, typically a parasitic drain-bulk diode which can be triggered into forward conduction by applying a negative drain potential. To address this an isolated NMOS process such as the ne3i process in from the XC018 family from the X-FAB, Germany may be employed (with a standard ne3i process for the remainder of the chiplet circuitry). This process provides a p-well transistor on a p⁻ epitaxial substrate, but in the isolated device the p-well is separated from the underlying substrate by a deep n-well layer. For n-well devices the pe3i/pe3 process may be employed.

Further in preferred embodiments the pixel driver circuit output stage is arranged to apply Vsb=0, by arranging for the source and bulk connections of cascode transistor 302 to be at a common potential (connecting the two): the p-well potential can then be lowered so that the Vdb=0 (zero drain-bulk potential) when applying a negative voltage, for example minus 2.2 (or more) volts, to the drain. In this case because the drain-bulk potential is zero there is no forward conduction of the parasitic drain-bulk diode. Although this is preferable it is not essential since the parasitic diode will also be substantially non-conducting even when a small forward voltage drop, below the on-voltage, is applied.

It might be thought that in embodiments of the invention, because the cascode transistor 302 is ‘exposed’, it might therefore age or fail earlier than would otherwise be the case. For example degradation of a device operating with an increased source-drain voltage results in a reduction in conductivity of the device due to hot electron damage. However, the cascode operation is relatively insensitive to such performance variations. Further, referring back to Tables 1-3 above, although the device sometimes operates with a high current and low Vsd, and with a low or zero current, the device does not operate with both a high current and a high voltage simultaneously, so the degradation is limited. A further failure mode is dielectric breakdown shorting the gate to the drain. However a typical OLED display panel operating temperature is considerably below the typical specification of the silicon process, for example 125° C., an thus this breakdown mode is no more likely than breakdown of another of the transistors, under standard conditions.

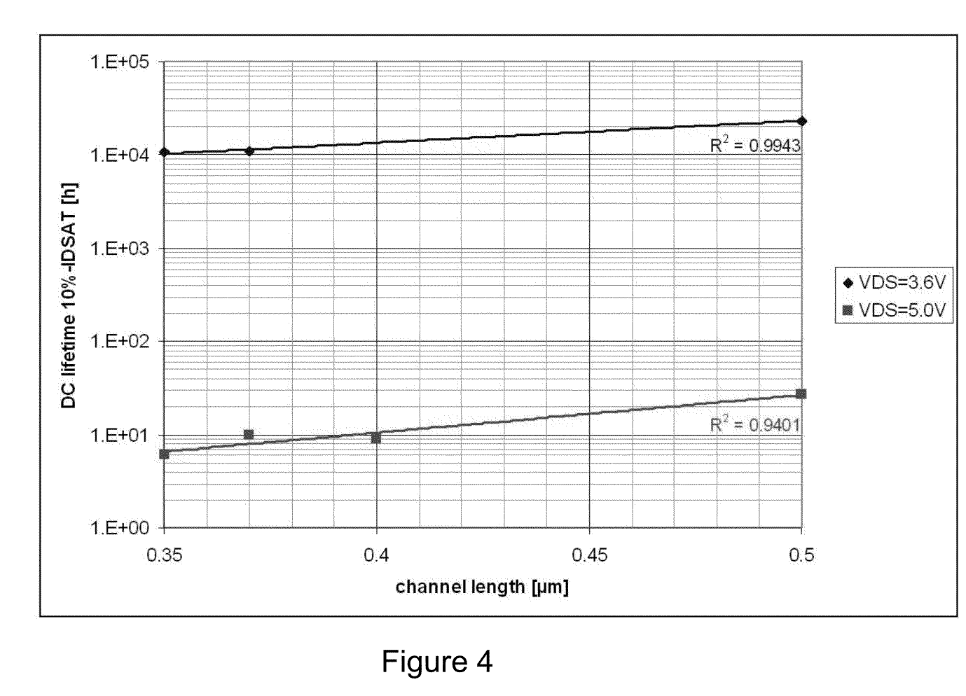

Referring now to FIG. 4, this shows, on a logarithmic scale, the effect of channel length and drain-source voltage on dc (direct current) lifetime of the cascode transistor in hours, where the lifetime is determined by a 10% in degradation of drain current saturation. Lines are indicated for drain-source voltages of 5 volts and 3.3 volts. It can be seen that the lifetime of the device, based on an assumed analogue-to-digital conversion factor of 50 and a gate length L of 0.5 μm, will be approximately 1500 hours for a drain-source voltage Vds of 5 volts.

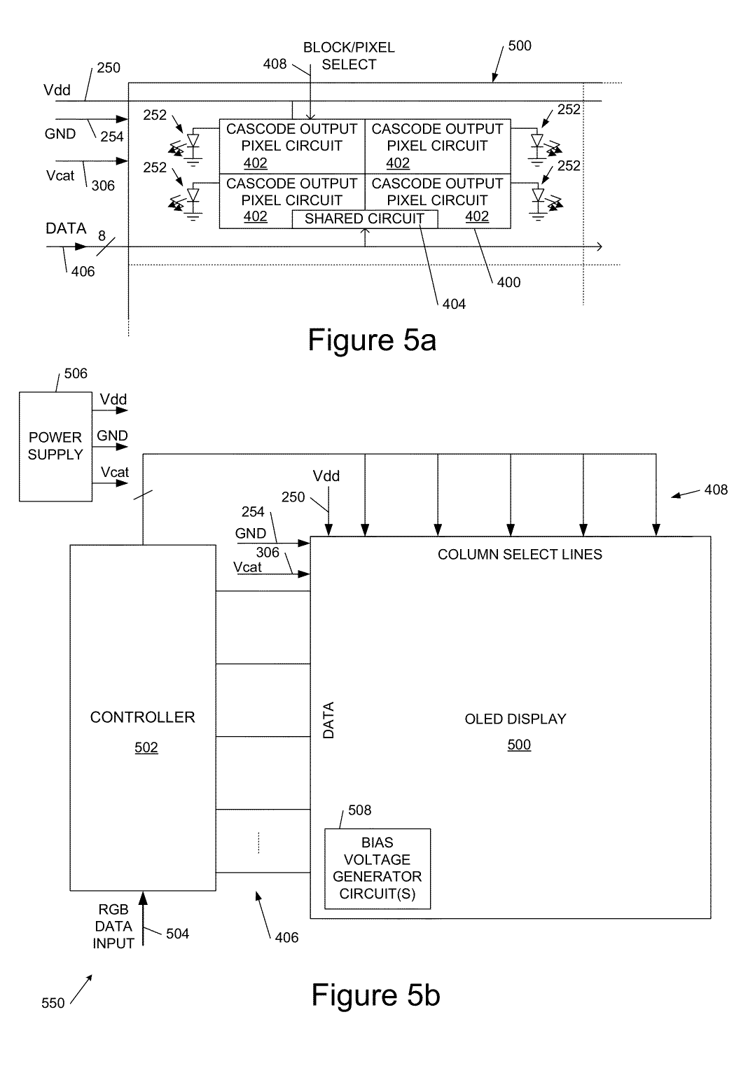

FIG. 5a shows a portion of an OLED display 500 bearing a plurality of chiplets 400, each chiplet comprising (in this example) a set of four OLED pixel driver circuits 402 each with a cascode output stage as illustrated in FIG. 3. The chiplet may also comprise shared circuitry 404 for the set of pixel driver circuits, for example to receive data from a digital data bus 406 for defining OLED drive levels for a chiplet. A set of block/pixel select lines 408 is also provided. The OLED display panel is supplied by a ground line 254, a V_{DD} line 250, and a Vcat line 306, as previously described (the bias voltage generation circuit is now shown in FIG. 5a).

FIG. 5b shows an OLED display system 550 including the OLED display 500 and a controller 502 to provide data and block/pixel select control information to the chiplets on the OLED display in response to colour (RGB) display data on input 504. The system also includes a power supply 506 to generate the V_{DD}, ground and OLED cathode power supply voltages. The display, as illustrated, includes one or more bias voltage generator circuits 508 to generate a bias voltage for the chiplets; in alternative arrangements such a circuit may be implemented on a chiplet or in power supply 506 or in controller 502.

For the avoidance of doubt, references to pixels in this specification may refer to a pixel that is only a single colour, or to a pixel which comprises a plurality of individually addressable sub-pixels that together enable the pixel to emit a range of colours to provide a colour display.

We have thus described techniques which enable the use of lower voltage silicon without the need for a level shifter or other bulky interface circuitry which would otherwise be needed between silicon areas operating at different voltages. In the techniques we describe we remove the effect of a parasitic diode between the output cascode and transistor drain and, if present, the output pad, to allow the drain of the cascode transistor to drop below a ground voltage. Furthermore by using a cascode transistor in the manner we describe, when operating as a cascode it is not unduly aged despite being operated beyond its nominal specification. A key feature of embodiments of the invention is that the drain of the cascode can go below Vss (ie negative/ground) of the chip. This enables use of a reduced geometry process, and therefore reduced cost, for driving an OLED without excessive leakage.

No doubt many other effective alternatives will occur to the skilled person. It will be understood that the invention is not limited to the described embodiments and encompasses modifications apparent to those skilled in the art lying within the spirit and scope of the claims appended hereto.

1. An organic light emitting diode (OLED) display, the display comprising:
a display substrate bearing a plurality of OLED pixels and having a plurality of chiplets mounted on said display substrate, wherein each said chiplet comprises a silicon integrated circuit coupled to a set of one or more said OLED pixels and bearing one or more pixel driver circuits for said set of one or more OLED pixels, and wherein each said chiplet is located adjacent said set of OLED pixels to which it is coupled;
wherein a said pixel driver circuit comprises an output pixel driver transistor having first and second drain/source connections and a control connection;
wherein said first drain/source connection is coupled to a first power supply line of said chiplet;
wherein said second drain/source connection provides a drive output to an associated said OLED pixel; and
wherein said pixel driver circuit further comprises a cascode transistor coupled between said second drain/source connection of said output pixel driver transistor and said associated OLED pixel, said cascode transistor having a first drain/source connection coupled to said second drain/source connection of said output pixel drive transistor, a second drain/source connection coupled to a first connection of said associated OLED pixel, and a control connection coupled to a bias voltage line.

2. An OLED display as claimed in claim 1 wherein said cascode transistor lacks a forward conducting parasitic diode between said second drain/source connection of said cascode transistor and a second power supply connection to said chiplet bearing said pixel driver circuit when said second drain/source connection of said cascode transistor is outside a power supply voltage range of said pixel driver circuit.

3. An OLED display as claimed in claim 2 wherein said cascode transistor lacks a forward conducting parasitic diode between said second drain/source connection of said cascode transistor and a substrate of said chiplet, wherein said substrate of said chiplet is connected to said second power supply connection.

4. An OLED display as claimed in claim 2 wherein said cascode transistor is a p-type transistor, wherein said second power supply connection is a ground connection of said chiplet, wherein said second drain/source connection of said cascode transistor is a drain connection of said cascode transistor, and wherein said cascode transistor lacks a said parasitic diode between said drain connection and said ground connection of said chiplet.

5. An OLED display as claimed in claim 2 wherein said cascode transistor is an n-type transistor wherein said second power supply connection is a positive power supply connection of said chiplet, wherein said second drain/source connection of said cascode transistor is a drain connection of said cascode transistor, and wherein said cascode transistor lacks a said parasitic diode between said drain connection and a positive power supply connection of said chiplet.

6. An OLED display as claimed in claim 1 further comprising an OLED power supply connection coupled to a second connection of said associated OLED pixel, wherein said OLED power supply connection is not connected to a ground connection of said chiplet bearing said pixel driver circuit.

7. An OLED display as claimed in claim 1 wherein said chiplet comprises an output pad coupled to said second drain/source connection of said cascode transistor, wherein said first connection of said associated OLED pixel is connected to said cascode transistor via said output pad, and wherein said output pad lacks a parasitic diode between said output pad and a substrate of said chiplet.

8. An OLED display as claimed in claim 1 further comprising a second power supply connection to said chiplet bearing said pixel driver circuit, and a bias voltage generation circuit coupled to provide a bias voltage to said bias voltage line, and wherein said bias voltage generation circuit is configured to provide a said bias voltage having a value intermediate between a voltage on said first power supply line of said chiplet and said second power supply connection to said chiplet.

9. An OLED display as claimed in claim 8 in combination with a power supply configured to provide first and second power supply voltages respectively to said first power supply line of said chiplet and to said second power supply connection to said chiplet, wherein said OLED display further comprises an OLED power supply connection coupled to a second connection of said associated OLED pixel, and wherein said power supply is further configured to provide an OLED voltage to said OLED power supply connection, and wherein said OLED voltage is outside a power supply voltage range defined by said first and second power supply voltages.

10. An OLED display as claimed in claim 9 wherein a difference between a voltage across said first and second connections of said associated OLED pixel when said pixel is on and when said pixel is off is greater than said power supply voltage range.

11. An OLED display as claimed in claim 9 wherein said first power supply voltage is a positive, V_{DD} voltage, said second power supply is a ground voltage, and wherein said OLED voltage is a negative voltage.

12. An OLED display as claimed in claim 1 wherein said cascode transistor is electrically isolated from a substrate of said chiplet.

13. An OLED display as claimed in claim 1 wherein said first drain/source connection of said cascode transistor is a source connection of said cascode transistor, and wherein said source connection of said cascode transistor is connected to a bulk connection of said cascode transistor.

14. An OLED display as claimed in claim 1 wherein said pixel driver circuit is fabricated on said chiplet in a 5 volts or less process, and wherein an ON voltage of a said OLED pixel is greater than a voltage of said process in which said pixel driver circuit is fabricated.

15. An OLED display as claimed in claim 1 wherein said output pixel driver transistor has a control connection, and wherein said pixel driver circuit further comprises a storage capacitor to store a programmed drive level for said pixel driver circuit coupled between said control connection of said input pixel driver transistor and said first power supply line of said chiplet.

16. A method of driving an organic light-emitting diode (OLED) display, the method comprising:
providing a plurality of pixel driver circuits for an OLED display on a plurality of chiplet silicon substrates, wherein each said pixel driver circuit comprises an output transistor for driving a first connection of an associated OLED pixel;
providing a cascode transistor on a said chiplet silicon substrate, wherein said cascode transistor is coupled between said output transistor and said first connection of said associated OLED pixel;
providing a power supply to said chiplet silicon substrate, said power supply defining a chiplet voltage range;
providing a second connection of said associated OLED pixel with an OLED voltage outside said chiplet voltage range; and
driving said associated OLED pixel using said pixel driver circuit on said chiplet over an OLED voltage range greater than said chiplet voltage range.

17. A method as claimed in claim 16 further comprising arranging said cascode transistor such that there is no forward conducing parasitic diode connected to said first connection of said associated OLED pixel.

18. A method as claimed in claim 17 wherein said fabricating of said cascode transistor comprises electrically isolating said cascode transistor from said silicon substrate.

19. A method as claimed in claim 17 further comprising arranging for a source and bulk connection of said cascode transistor to be at a common potential and arranging a drain-bulk potential of said cascode transistor to be zero at a drain voltage of said cascode transistor outside said chiplet voltage range.

20. A method as claimed in claim 17 wherein said steps of providing said plurality of pixel driver circuits and of providing said cascode transistor use a silicon fabrication process specified for a voltage less than said OLED voltage range.

21. A method as claimed in claim 17 wherein said power supply to said chiplet silicon substrate includes a ground or negative power supply connection at a ground or negative power supply voltage, and wherein said driving of said associated OLED pixel comprises controlling a drain connection of said cascode transistor to a voltage below said ground or negative power supply voltage.

22. A system for driving an organic light-emitting (OLED) display, the display comprising:
a plurality of pixel driver circuits for the display on a plurality of chiplet silicon substrates, wherein each said pixel drier circuit comprises an output transistor for driving a first connection of an associated OLED pixel;
a cascode transistor on a said chiplet silicon substrate, wherein said cascode transistor is coupled between said output transistor and said first connection of said associated OLED pixel; and
a power supply to said chiplet silicon substrate, said power supply defining a chiplet voltage range;
a line connecting a second connection of said associated OLED pixel to an OLED voltage outside said chiplet voltage range;
wherein a said pixel driver circuit is configured to drive said associated OLED pixel using said pixel driver circuit on said chiplet over an OLED voltage range greater than said chiplet voltage range.

23. A system for driving an OLED display as claimed in claim 22 wherein said power supply to said chiplet silicon substrate includes a ground or negative power supply connection at a ground or negative power supply voltage, and wherein said cascode transistor is biased such that a drain connection of said cascode transistor is at a voltage below said ground or negative power supply voltage.
